(19) United States
(12) Patent Application Publication
(10) Pub. No.: US 2012/0153729 A1
(43) Pub. Date: Jun. 21, 2012

(54) MULTI-INPUT BIDIRECTIONAL DC-DC CONVERTER

(75) Inventors: Yujin SONG, Daejeon-si (KR); Soo-Bin Han, Daejeon-si (KR); Sukin Park, Daejeon-si (KR); Hak-Geun Jeong, Daejeon-si (KR); Su-Yong Chae, Daejeon-si (KR); Gyu-Duk Kim, Daejeon-si (KR); Seung-Weon Yu, Daejeon-si (KR)

(73) Assignee: KOREA INSTITUTE OF ENERGY RESEARCH, Daejeon-si (KR)

(21) Appl. No.: 12/974,891

(22) Filed: Dec. 21, 2010

(30) Foreign Application Priority Data
Dec. 17, 2010 (KR) 10-2010-0130283

(51) Int. Cl. H02J 1/00; H02M 3/335

(52) U.S. Cl. 307/82; 363/17

(57) ABSTRACT

Provided is technology for charge and discharge control of a plurality of energy storage modules having different properties. For achieving the technology, there is provided a multi-input bidirectional DC-DC converter including: a first bidirectional DC-DC converter including a first input unit which stores an input current from a first energy storage module, a primary-side first half-bridge which is connected to the first input unit and controls an input current from the first energy storage module, an output unit which includes an output capacitor, a secondary-side half-bridge which is connected to the output unit and controls the output voltage, and a first transformer whose primary side is connected to the primary-side first half-bridge, whose secondary side is connected to the secondary-side first half-bridge, and which transforms a voltage at the primary side or at the secondary side according to a power mode; and a n-th bidirectional DC-DC converter.

### CROSS-REFERENCE TO RELATED APPLICATION

This application claims the benefit under 35 U.S.C. §119(a) of a Korean Patent Application No. 10-2010-0130283, filed on Dec. 17, 2010, the entire disclosure of which is incorporated herein by reference for all purposes.

### BACKGROUND

1. Field

The following description relates to a bidirectional DC-DC converter, and more particularly, to a multi-input bidirectional DC-DC converter with multiple energy storage modules.

2. Description of the Related Art

Renewable energy is currently being introduced worldwide to solve global warming and environmental pollution problems. However, renewable energy, such as wind power or photovoltaic, greatly depends on climatic and geographical environments due to its intermittent output characteristics and accordingly has difficulties in predicting the generation amount of energy. Because of these characteristics, distributed generation system using renewable energy may cause instability of power grid and degradation of power quality. In addition, a large time difference between generation and consumption of renewable energy makes it difficult to utilize energy efficiently.

Meanwhile, the output fluctuation of renewable energy can be reduced by a grid stabilization system with energy storage, such as battery and supercapacitor, through parallel operation with a distributed generation system. The grid stabilization system also can minimize the time difference between generation and consumption of renewable energy by storing excess energy in a large capacity secondary battery and supplying the stored energy to the consumer during peak times of energy consumption.

For parallel operation of the grid stabilization system with the distributed generation system, a large capacity energy storage system is required. Recently, a lithium ion battery is widely used in the industry due to its rapid rate of charge and discharge and high energy density. In the case of a large capacity energy storage system using lithium ion battery, it is necessary to connect multiple cells in series and in parallel. In particular, in a cell group in which many cells of low internal resistance are connected in series and in parallel, when an unlikely occurrence of cell failure causes a voltage drop at a particular cell, a large current may flow into a parallel connection from the remaining cells. In order to avoid this phenomenon, the current and voltage were controlled at the point where series cell are connected in parallel.

### SUMMARY

The following description relates to technology of independently controlling charging and discharging of multiple energy storages including a plurality of battery cell modules or a plurality of super capacitor modules, which have different impedance characteristics or different state of charge.

In one general aspect, there is provided a multi-input bidirectional DC-DC converter including: a first bidirectional DC-DC converter including a first input unit which stores input current from a first energy storage module, a first primary half-bridge which is connected to the first input unit and controls the input current from the first energy storage module, an output unit which includes an output capacitor, a first secondary half-bridge which is connected to the output unit and controls the output voltage, and a first transformer whose primary side is connected to the first primary half-bridge, whose secondary side is connected to the first secondary half-bridge, and which transforms a voltage at the primary side or at the secondary side according to a power mode; and a n-th bidirectional DC-DC converter including a n-th input unit which stores input current from a n-th energy storage module, a n-th primary half-bridge which is connected to the n-th input unit and controls the input current from the n-th energy storage module, a n-th secondary half-bridge which is connected to the output unit of the first bidirectional DC-DC converter and controls the output voltage, and a n-th transformer whose primary side is connected to the n-th primary half-bridge, whose secondary side is connected to the n-th secondary half-bridge, and which transforms a voltage at the primary side or at the secondary side according to a power mode, wherein the n-th supply voltage bidirectional DC-DC converter is composed of one or more n-th supply voltage bidirectional DC-DC converters.

In another general aspect, there is provided a 3-phase bidirectional DC-DC converter, which is controlled by multiple independent control loops, including: three primary half-bridges including three energy storage modules and three inductors respectively connected to the three energy storage modules; an output capacitor; three secondary half-bridges connected to both terminals of the output capacitor and provided respectively in correspondence to the three primary half-bridges; and three 3-phase high frequency transformers connected to the three primary half-bridges and the three secondary half-bridges in a Y-Y connection form.

Therefore, it is possible to independently control charging and discharging of a plurality of energy storage modules having different characteristics. Since different phase control loops are independently controlled so that the failure of a battery module does not affect other battery modules. In addition, when a battery module is used as an energy storage, a current-controlled loop is used for load following, and when a super capacitor module is used as an energy storage, higher-frequency load follow control and the DC link voltage control of a stabilization system or a DC micro-grid can be implemented.

Other features and aspects will be apparent from the following detailed description, the drawings, and the claims.

### BRIEF DESCRIPTION OF THE DRAWINGS

FIG. 1 is a circuit diagram illustrating an example of a multi-input bidirectional DC-DC converter.

FIG. 2 is a circuit diagram illustrating an example of a 3-phase bidirectional DC-DC converter.

FIG. 3 is waveforms for explaining the operation waveforms of the 3-phase bidirectional DC-DC converter.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

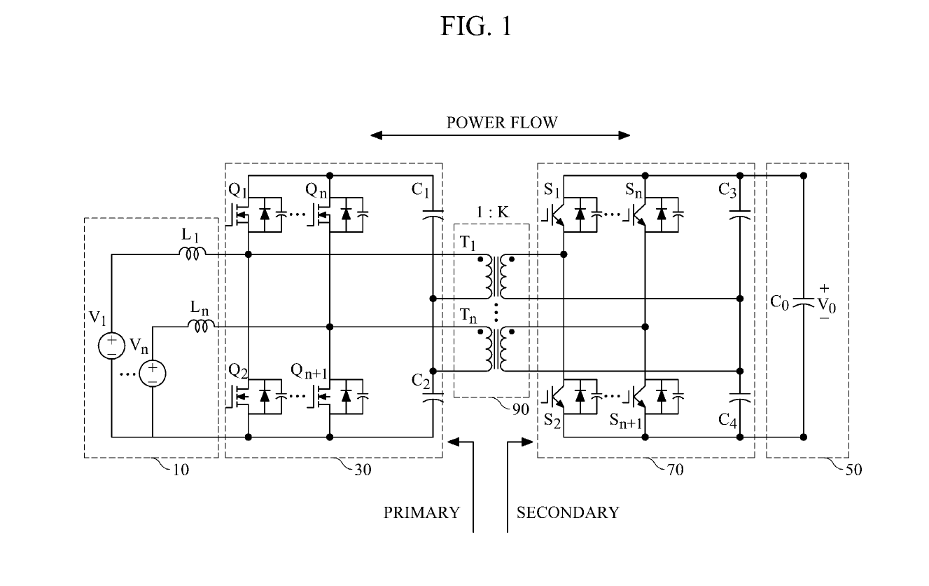

FIG. 1 is a circuit diagram illustrating an example of a multi-input bidirectional DC-DC converter.

Referring to FIG. 1, the multi-input bidirectional DC-DC converter includes two or more input units 10, two or more primary half-bridges 30, an output unit 50, two or more secondary half-bridges 70, and two or more transformers 90. In detail, the input units 10 include multiple energy storage modules V₁, . . . , Vₙ and multiple input inductors L₁, . . . , Lₙ connected respectively to the energy storage modules V₁, . . . , Vₙ, the primary half-bridges 30 include capacitors C₁ and C₂ and a plurality of switches Q₁, . . . , Qₙ, Qₙ₊₁ connected to the input units 10, the output unit 50 has both terminals of an output capacitor C₀ as its output, the second half-bridges 70 include capacitors C₃ and C₄ and a plurality of switches S₁, S₂, . . . , Sₙ, Sₙ₊₁ connected to the output unit 50, and the transformers 90, whose one ends are connected to the primary half-bridges 30 and whose other ends are connected to the secondary half-bridges 79, steps up the primarily voltage by a voltage conversion ratio.

As described above, the input units 10 include a plurality of energy storage modules V₁, . . . , Vₙ and a plurality of input inductors L₁, . . . , Lₙ connected respectively to energy storage modules V₁, . . . , Vₙ, and each energy storage modules V₁, . . . , Vₙ is a battery or a super capacitor. The input units 10 include two or more different energy storage modules that are charged and discharged independently. For example, when the multi-input bidirectional DC-DC converter is a 3-phase bidirectional DC-DC converter, the input units 10 include three different energy storage modules.

If first, second and third energy storage modules are connected in parallel to each other and then connected to a single DC-DC converter, a voltage difference occurs between the first and third energy storage module when the second energy storage module is malfunctioned. In this case, current from the first and third energy storage module flows to the second energy storage module, which may reduce the life time of the second energy storage module. Accordingly, the multi-input bidirectional DC-DC converter having the plurality of energy storage modules V₁, . . . , Vₙ is controlled by independent loops in order to independently control the individual energy storage module. The input inductors L₁, . . . , Lₙ are respectively connected in series to the corresponding energy storage modules V₁, . . . , Vₙ. The input inductors L₁, . . . , Lₙ store current from the energy storage modules V₁, . . . , Vₙ as an energy, and the stored energy is transmitted to the secondary sides via the primary half-bridges 30 and the transformers 90. Accordingly, energy storage modules V₁, . . . , Vₙ may be independently controlled, so that the malfunction of any one of the to energy storage modules V₁, . . . , Vₙ does not affect the other energy storage modules, which contributes to the life time extension of the energy storage modules V₁, . . . , Vₙ.

The primary half-bridges 30 basically include two switches Q₁ and Q₂ and two capacitors C₁ and C₂. In this case, the primary half-bridges 30 are positioned at the primary sides of the transformers 90. The switches Q₁ and Q₂ are Insulated Gate Bipolar Transistors (IGBTs) or MOS Field-Effect Transistors (MOSFETs). Each of the switches Q₁ and Q₂ is connected in parallel to a lossless capacitor. The lossless capacitor is used for soft switching implementation. In the multi-input bidirectional DC-DC converter, the primary sides have a lower voltage than the secondary sides. When the multi-input bidirectional DC-DC converter is in a boost mode, energy flows from the energy storage modules of the primary sides to the output terminal of the secondary sides.

The primary half-bridges 30 are connected to the input units 10 and the transformers 90. Also, the primary half-bridges 30 allow zero voltage switching. When the multi-input bidirectional DC-DC converter is in the boost mode, the primary half-bridges 30 modulate DC current from the energy storage modules V₁, . . . , Vₙ of the input units 10 to the high frequency current pulses and transmit them to the secondary sides through the transformers 90. The secondary half-bridges 70 rectify the high frequency current pulses and transmit the rectified current to the output unit 50. When the multi-input bidirectional DC-DC converter is in a buck mode, the primary half-bridges 30 rectify the high frequency current pulses received from the s secondary half-bridge 70 through the transformers 90 and transmit the rectified current to the input units 10.

The multi-input bidirectional DC-DC converter allows independent control with respect to each phase of the converter. If an energy storage module is added to the multi-input bidirectional DC-DC converter, a primary half-bridge 30 connected to the added energy storage module includes two switches (for example, Qₙ and Qₙ₊₁). Accordingly, when another bidirectional DC-DC converter is added to the multi-input bidirectional DC-DC converter, the primary half-bridges of the entire converter additionally include two switches.

The output unit 50 includes a capacitor C₀. The multi-input bidirectional DC-DC converter according to the current example has a single output regardless of the number of input energy storage modules. The output unit 50 of the multi-input bidirectional DC-DC converter may be connected to a DC input terminal of a grid-connected inverter, to a DC output terminal of a distributed generation converter or to a DC input terminal of a load converter.

When the multi-input bidirectional DC-DC converter is in the boost mode, energy flows from the input units 10 to the output unit 50. The energy is stored in the capacitor C₀ of the output unit 50, and then supplied to an external power system via a DC input terminal. When the multi-input bidirectional DC-DC converter is in a buck mode, energy flows from the output unit 50 to the input units 10. In this case, the capacitor C₀ of the output unit 50 stores energy transmitted from the external power system and then transmits the energy to the input units 10 via the secondary half-bridges 70 and transformers 90.

The secondary half-bridges 70 basically include two switches S₁ and S₂ and two capacitors C₃ and C₄. In this case, the secondary half-bridges 70 are positioned at the secondary sides of the transformers 90. The switches S₁ and S₂ also are IGBTs or MOSFETs. Each of the switches S₁ and S₂ is connected in parallel to a lossless capacitor. The lossless capacitor is used for soft switching implementation.

In the multi-input bidirectional DC-DC converter, the primary sides have a lower voltage than the secondary sides. When the multi-input bidirectional DC-DC converter is in the buck mode, energy flows from the secondary sides (high voltage) to the primary sides (low voltage), whereas when the multi-input bidirectional DC-DC converter is in the boost mode, energy flows from the primary sides to the secondary sides. When the multi-input bidirectional DC-DC converter is in the buck mode, the secondary half bridges 70 modulates the DC current of the output unit 50 to high frequency current pulses and transmit them to the primary sides through the transformers 90. Meanwhile, when the multi-input bidirectional DC-DC converter is in the boost mode, the secondary half-bridges 70 rectify the pulse current transmitted through the transformers 90 and transmit the rectified current to the output unit 50.

The multi-input DC-DC converter according to the current example allows independent control with respect to each primary half-bridges 30 connected to a energy storage module, and also allows independent control of the secondary half-bridge 70 corresponding to the primary half-bridge 30. When another energy storage module is added to the multi-input bidirectional DC-DC converter, the primary half-bridges 30 connected to the added energy storage module includes two switches Qₙ and Qₙ₊₁, and the secondary half-bridges 70 corresponding to the primary half-bridges 30 also include two switches Sₙ and Sₙ₊₁. Accordingly, when another bidirectional DC-DC converter is added to the multi-input bidirectional DC-DC converter, the secondary half-bridges of the entire converter additionally include two switches.

The transformers 90 transform a voltage from the primary sides and apply the transformed voltage to the secondary sides. The transformer 90 electrically isolates energy storage modules from loads. The transformers 90 have a predetermined turn ratio of 1: K and transform a voltage from the primary sides. The transformers 90 step up the primary voltage by a voltage conversion ratio. Since the multi-input bidirectional DC-DC converter configure an independent control loop for each energy storage module, two switches are added to each of the primary half-bridges 30 and secondary half-bridges 70 whenever a new energy storage module is added to the multi-input bidirectional DC-DC converter. Accordingly, whenever a new energy storage module is added to the multi-input bidirectional DC-DC converter, a transformer is added to each pair of the primary half-bridges 30 and secondary half-bridges 70.

FIG. 1 detailedly shows the connection relationship of circuit components that configure the multi-input bidirectional DC-DC converter. If the multi-input bidirectional DC-DC converter is a n-phase bidirectional DC-DC converter, n independent energy storage modules V₁, . . . , Vₙ are connected in parallel, and n input inductors L₁, . . . , Lₙ are respectively connected in is series to the individual energy storage modules V₁, . . . , Vₙ. A primary half-bridge is connected to each of connection lines of the energy storage modules V₁, . . . , Vₙ and input inductors L₁, . . . , Lₙ. The primary half-bridge includes two primary switches Q₁ and Q₂ and two capacitors C₁ and C₂. If another independent energy storage module Vₙ is added to the multi-input bidirectional DC-DC converter, another primary half-bridge is also added. In this case, two switches (for example, Qₙ and Qₙ₊₁) are added and the capacitors C₁ and C₂ are shared with the other primary half-bridges.

The n-phase bidirectional DC-DC converter includes a plurality of transformers T₁, . . . , Tₙ corresponding to the number of independent energy storage modules V₁, . . . , Vₙ. Each of the transformers T₁, . . . , Tₙ is a high frequency transformer and is connected to both the primary and secondary sides, that is, to both the primary and secondary half-bridges, in a Y-Y connection form. In this case, one ends of the primary sides of the transformers T₁, . . . , Tₙ are connected to contacts of the switches Q₁, . . . , Qₙ, Qₙ₊₁ included in the primary half-bridges, and the other ends of the primary sides of the transformers T₁, . . . , Tₙ are connected to a contact of the capacitors C₁ and C₂ of the primary half-bridges. In detail, one end of the primary side of each of the transformers T₁, . . . , Tₙ is connected to a contact of two switches belonging to different primary half-bridges, and the other end of the primary side of each of the transformers T₁, . . . , Tₙ is connected to the contact of the capacitors C₁ and C₂ at the same primary side. When a new independent energy storage module is added to the multi-input bidirectional DC-DC converter, two switches (for example, Qₙ and Qₙ₊₁) are added to configure a primary half-bridge connected to the energy storage module, while the capacitors C₁ and C₂ are shared with the primary half-bridges of other energy storage modules.

One end of the secondary side of each of the transformers T₁, . . . , Tₙ is connected to the contact of two switches belonging to the corresponding secondary half-bridge, and the other end of the secondary side of each of the transformers T₁, . . . , Tₙ is connected to the contact of capacitors C₃ and C₄ of the secondary half-bridge. In detail, one end of the secondary side of each of the transformers T₁, . . . , Tₙ is connected to the contact of two switches included in different secondary half-bridges, and the other end of the secondary side of each of the transformers T₁, . . . , Tₙ is connected to the contact of capacitors C₃ and C₄ at the same secondary side. When a new independent energy storage module is added to the multi-input bidirectional DC-DC converter, two switches Sₙ and Sₙ₊₁ are added to configure a second half-bridge, while the capacitors C₃ and C₄ are shared with secondary half-bridges of other energy storage modules.

A secondary half-bridge includes two switches (for example, S₁ and S₂) and the two capacitors C₃ and C₄. Whenever a new independent energy storage module is added to the multi-input bidirectional DC-DC converter, another secondary half-bridge is also added. In this case, the secondary half-bridge, which is newly added, is composed by adding two switches (for example, Sₙ and Sₙ₊₁) and sharing the capacitors C₃ and C₄ with other secondary half-bridges. The multi-input bidirectional DC-DC converter according to the current example includes a single output capacitor C₀. Accordingly, a plurality of secondary half-bridges are connected to the single output capacitor C₀.

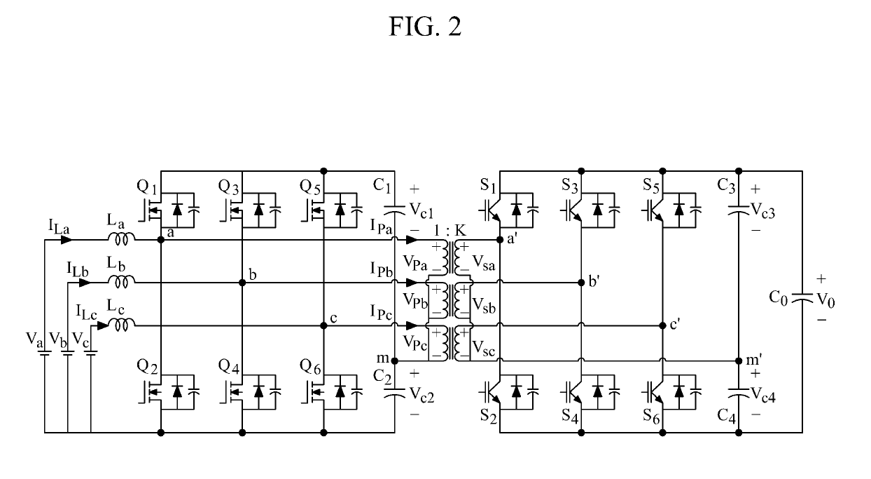

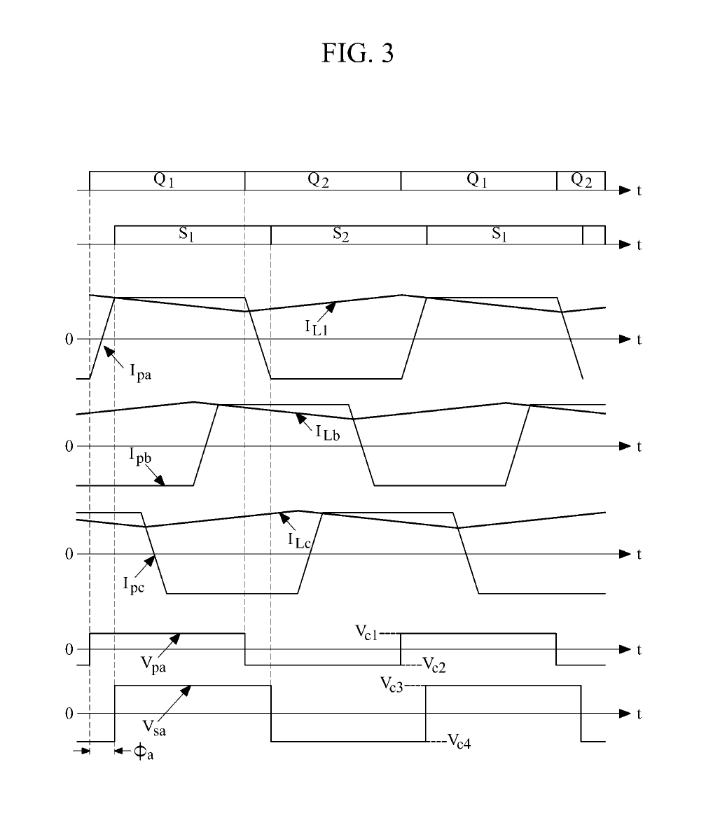

FIG. 2 is a circuit diagram illustrating an example of a 3-phase bidirectional DC-DC converter, and FIG. 3 is operation waveforms for explaining the operation of the 3-phase bidirectional DC-DC converter.

Referring to FIG. 2, the 3-phase bidirectional DC-DC converter includes 3-phase high frequency transformers with Y-Y connection at both primary and secondary sides. The primary sides of the 3-phase high frequency transformers include three input inductors Lₐ, L_{b} and L_{c}, and three half-bridges. The three half-bridges include first through sixth switches Q₁ through Q₆ and first and second capacitors C₁ and C₂ at the primary sides. In this case, one ends of the primary sides of the 3-phase high frequency transformers are connected to the contacts a, b and c of the corresponding half-bridges. Also, the other ends of the primary sides of the 3-phase high frequency transformer are connected in common to the contact m of the first and second capacitors C₁ and C₂.

Meanwhile, the secondary sides of the 3-phase high frequency transformers include three half-bridges and an output capacitor C₀. The three half-bridges include first through sixth switches S₁ through S₆, and third and fourth capacitors C₃ and C₄ s at the secondary sides. An output capacitor C₀ is connected to one ends of the third and fourth capacitors C₃ and C₄. One ends of the secondary sides of the 3-phase high frequency transformers are connected to the contacts a′, b′ and c′ between the corresponding switches S₁ through S₆, and the other ends of the secondary sides of the 3-phase high frequency transformers are connected to the contact m′ of the third and fourth capacitors C₃ and C₄.

FIG. 3 is waveforms for explaining the theoretical operation of the 3-phase bidirectional DC-DC converter illustrated in FIG. 2. Referring to FIGS. 2 and 3, in the 3-phase bidirectional DC-DC converter including an a-phase energy storage module Vₐ, the first switch Q₁ at the primary side and the first switch S₁ at the secondary side have turn-on times. I_{La}, I_{Lb} and I_{Lc} respectively represent inductor currents flow through a-phase, b-phase and c-phase inductors Lₐ, L_{b} and L_{c}, and Iₚₐ, I_{pb} and I_{pc} represent primary side currents of the 3-phase high frequency transformers. Vₚₐ represents an a-phase primary voltage of the 3-phase high frequency transformers, and Vₛₐ represents an a-phase secondary voltage of the 3-phase high frequency transformer. V_{c1} represents a voltage at both terminals of the first capacitor C₁, V_{c2} represents a voltage at both terminals of the second capacitor C₂, V_{c3} represents a voltage at both terminals of the third capacitor C₃, and V_{c4} represents a voltage at both terminals of the fourth capacitor C₄.

There is a phase shift φₐ between the a-phase primary square wave voltage Vₚₐ and a-phase secondary square wave voltage Vₛₐ of the transformers. The phase shift (φₐ, φ_{b}, φ_{c}) between the primary and secondary determines the amount of power transmitted through the multi-input bidirectional DC-DC converter. An each-phase half-bridge operates at a duty ratio of 50%. In the multi-input bidirectional DC-DC converter, each-phase input current can be independently controlled.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A multi-input bidirectional DC-DC converter comprising:
a first bidirectional DC-DC converter including a first input unit which stores input current from a first energy storage module, a first primary half-bridge which is connected to the first input unit and controls the input current from the first energy storage module, an output unit which includes an output capacitor, a first secondary half-bridge which is connected to the output unit and controls the output voltage, and a first transformer whose primary side is connected to the first primary half-bridge, whose secondary side is connected to the first secondary half-bridge, and which transforms a voltage at the primary side or at the secondary side according to a power mode; and
a n-th supply voltage bidirectional DC-DC converter including a n-th input unit which stores input current from a n-th energy storage module, a n-th primary half-bridge which is connected to the n-th input unit and controls the input current from the n-th energy storage module, a n-th secondary half-bridge which is connected to the output unit of the first bidirectional DC-DC converter and controls the output voltage, and a n-th transformer whose primary side is connected to the n-th primary half-bridge, whose secondary side is connected to the n-th secondary half-bridge, and which transforms a voltage at the primary side or at the secondary side according to a power mode,
wherein the n-th supply voltage bidirectional DC-DC converter is composed of one or more n-th supply voltage bidirectional DC-DC converters.

2. The multi-input bidirectional DC-DC converter of claim 1, wherein the first bidirectional DC-DC converter further comprises an output capacitor,
the first input unit includes a first input inductor connected to the first energy storage module,
the first primary half-bridge includes a first primary switch connected to the first input inductor, a second primary switch, a first capacitor, and a second capacitor,
the first secondary half-bridge includes a first secondary switch, a second secondary switch, a third capacitor, and a fourth capacitor, which are connected to the output capacitor, and
the primary-side one end of the first transformer is connected to a contact of the first primary switch and the second primary switch, the primary-side other end of the first transformer is connected to a contact of the first capacitor and the second capacitor, the secondary-side one end of the first transformer is connected to a contact of the first secondary switch and the second secondary switch, and the secondary-side other end of the first transformer is connected to a contact of the third capacitor and the fourth capacitor.

3. The multi-input bidirectional DC-DC converter of claim 2, wherein
the n-th input unit includes a n-th input inductor connected to the n-th energy storage module;
the n-th primary half-bridge includes a n-th primary switch connected to the n-th input inductor, a (n+1)-th primary switch, the first capacitor, and the second capacitor;
the n-th secondary half-bridge includes a n-th secondary switch, a (n+1)-th secondary switch, the third capacitor, and the fourth capacitor, which are connected to both terminals of the output capacitor; and
the primary-side one end of the n-th transformer is connected to a contact of the n-th primary switch and the (n+1)-th primary switch, the primary-side other end of the n-th transformer is connected to a contact of the first capacitor and the second capacitor, the secondary-side one end of the n-th transformer is connected to a contact of the n-th secondary switch and the (n+1)-th secondary switch, and the secondary-side other end of the n-th transformer is connected to a contact of the third capacitor and the fourth capacitor.

4. A 3-phase bidirectional DC-DC converter, which is controlled independently, comprising:
three input units including three energy storage modules and three inductors respectively connected to the three energy storage modules, wherein the three energy storage modules are respectively connected to the three inductors;
three primary half-bridges, wherein the three primary half-bridges are respectively connected to the three inductors;
an output capacitor;
three secondary half-bridges connected to both terminals of the output capacitor and provided respectively in correspondence to the three primary half-bridges; and
is three-phase high frequency transformer connected to the three primary half-bridges and the three secondary half-bridges in a Y-Y connection form.
